(19) United States
(12) Patent Application Publication
(10) Pub. No.: US 2024/0249331 A1
(43) Pub. Date: Jul. 25, 2024

(54) PRODUCT DESCRIPTION AUGMENTATION

(71) Applicant: ADOBE INC., SAN JOSE, CA (US)

(72) Inventors: Ajay Jain, San Jose, CA (US); Michele Saad, Austin, TX (US)

(21) Appl. No.: 18/157,854

(22) Filed: Jan. 23, 2023

(51) Int. Cl. G06Q 30/0601; G06Q 30/0282

(52) U.S. Cl. CPC G06Q 30/0627; G06Q 30/0282

(57) ABSTRACT

Systems and methods for product description augmentation are provided. According to one aspect, a method for product augmentation includes performing, by an attribute inference component, a semantic analysis of a product review for a product to obtain review data including an attribute of the product; computing, by a delta component, a difference between the review data and a product description for the product, wherein the difference includes the attribute; and generating, by a generative machine learning model, an augmented product description for the product based on the difference, wherein the augmented product description describes the attribute.

### BACKGROUND

The following relates generally to data processing, and more specifically to product description augmentation. Data processing refers to the collection and manipulation of data to produce meaningful information. A large portion of data processing is devoted to describing products on internet-based user interfaces (such as apps and websites). In many such user interfaces, product descriptions are displayed alongside other product information (such as images) and reviews of the product provided by consumers. A consumer may make a decision to purchase the product based on a combination of the product description, the other product information, and the reviews of the products.

Product reviews will often include information that consumers deem to be important, but is absent from or not appropriately prominent in the product description. However, manually surfacing this important information from product reviews is a laborious and time-consuming task. There is therefore a need in the art for systems and methods that more efficiently combine additional information with an existing product review.

### SUMMARY

Embodiments of the present disclosure provide a data processing system that discovers a salient product feature in a review of the product and determines whether an existing description of the product appropriately includes the salient product feature. In some cases, the data processing system uses a generative machine learning model to generate a new product description based on the existing product description, where the new product description includes the salient product feature.

A method, apparatus, non-transitory computer readable medium, and system for data processing are described. One or more aspects of the method, apparatus, non-transitory computer readable medium, and system include performing a semantic analysis of a product review for a product to obtain review data including an attribute of the product; computing a difference between the review data and a product description for the product, wherein the difference includes the attribute; and generating an augmented product description for the product based on the difference, wherein the augmented product description describes the attribute.

An apparatus and system for product description augmentation are described. One or more aspects of the apparatus and system include an attribute inference component configured to perform a semantic analysis of a product review for a product to obtain review data including an attribute of the product; a delta component configured to compute a difference between the review data and a product description for the product, wherein the difference includes the attribute; and a generative machine learning model configured to generate an augmented product description for the product based on the difference, wherein the augmented product description describes the attribute.

### BRIEF DESCRIPTION OF THE DRAWINGS

FIG. 1 shows an example of a data processing system according to aspects of the present disclosure.

FIG. 2 shows an example of a data processing apparatus according to aspects of the present disclosure.

FIG. 3 shows an example of data flow in a data processing system according to aspects of the present disclosure.

FIG. 4 shows an example of data flow in a data processing apparatus according to aspects of the present disclosure.

FIG. 5 shows an example of a method for augmenting a product description according to aspects of the present disclosure.

FIG. 6 shows an example of a method for generating an augmented product description according to aspects of the present disclosure.

FIG. 7 shows an example of an augmented product description according to aspects of the present disclosure.

FIG. 8 shows an example of a method for generating a subsequent augmented product description according to aspects of the present disclosure.

### DETAILED DESCRIPTION

Embodiments of the present disclosure relate generally to data processing, and more specifically to product description augmentation. A large portion of data processing is devoted to describing products on internet-based user interfaces (such as apps and websites). In many such user interfaces, product descriptions are displayed alongside other product information (such as images) and reviews of the product provided by consumers. Merchandisers are responsible for describing a product and highlighting important features of the product in as clear and appealing a fashion as possible given visual constraints of the user interfaces. For example, to encourage a purchase of the product, the product description should be succinct, clear, and effective, and should prominently include the important features in a salient manner.

In addition to a product's description, a consumer may also make a decision to purchase a product based on other product information (such as an image of the product), and especially consumer reviews of the products. However, a consumer may not want to or be able to read through a number of product reviews to find information that they are interested in with regards to a product. Furthermore, that information and interest may change over time (e.g., whether a product includes or does not include a particular material may become important when concerns over the use of that material arise). Accordingly, it is in the interest of both a merchandiser and a consumer for important, relevant information included in product reviews to be surfaced in the product description, and for the product description to be updated over time when time-relevant important information becomes available.

However, manually examining product reviews to determine information included in the product reviews to be included in the product description is a laborious and time-consuming process, assumes a knowledge of what information is being looked for, and also requires attention to be paid to individual products to determine when and how their product descriptions should be updated, which may not be feasible at scale.

According to an aspect of the present disclosure, a data processing system includes an attribute inference component, a delta component, and a generative machine learning model. According to some aspects, the attribute inference component is configured to perform a semantic analysis of a product review for a product to obtain review data including an attribute of the product. According to some aspects, the delta component is configured to compute a difference between the review data and a product description for the product. In some cases, the difference includes the attribute. According to some aspects, the generative machine learning model is configured to generate an augmented product description for the product based on the difference. In some cases, the augmented product description describes the attribute.

By performing the semantic analysis of the product review to obtain the review data, the attribute inference component automatically determines an attribute included in the product review, rather than relying on a manual examination of the product review to determine the attribute, and thereby provides an increased efficiency over existing data processing technologies. In some cases, the attribute is determined based on a confidence score computed using a machine learning model. Accordingly, in some cases, the attribute inference component is able to determine whether information included in the product review is an important attribute without manually searching the product review for a specific attribute, thereby providing a further increased efficiency over existing data processing technologies.

Furthermore, by determining the difference based on the product description and the parsed text, the delta component surfaces an insight about the relationship between the product description and the attribute included in the product review by identifying, detecting, and uncovering the relationship. For example, an insight can be an understanding of the relationship, where this understanding was previously hidden or not known. Additionally, in some cases, the insight is provided without a user's determination that a difference should be determined for any one particular product. A comparable insight provided by a conventional data processing system would only be available by a manual examination of the product description and the product review, with foreknowledge of what product description should be updated and what information is being looked for with regards to the associated product.

Finally, by generating the augmented product description for the product based on the difference, the generative machine learning model is able to incorporate the attribute into a new product description. In some cases, the augmented product description includes the attribute to a degree of prominence that reflects a confidence score associated with the attribute. Furthermore, in some cases, a subsequent augmented product description can be generated in a similar manner over time (and, in some cases, continuously at regular intervals or at periods of high review activity) using information from an additional product review. Accordingly, the data processing system is able to produce a new product description for a product that includes information deemed by consumers to be relevant to their interests in a more efficient, trend-cognizant, and less laborious manner than conventional data processing systems provide.

As used herein, a “product” refers to any item, good, service, etc. that can be made available through an online graphical user interface (such as an app, a website, an email, etc.).

As used herein, a “product review” refers to text that is provided by a consumer of a product. In some cases, the product review is intended to be evaluative of the product. In some cases, the product review is provided by the consumer to a user interface associated with the product. In some cases, the product review is provided to a different user interface and is imported into the user interface associated with the product by an administrative user. In some cases, the product review is displayed in the user interface associated with the product.

As used herein, a “product description” refers to text that is descriptive of the product and is separate from a product review. For example, in some cases, a product description is provided by a merchandiser of the product, a creator of the product, a retailer of the product, etc., but is not provided by a consumer of the product. In some cases, a product description is displayed in the user interface associated with the product. In some cases, the product description is provided to the user interface by the merchandiser, creator, retailer, etc. In some cases, the product description is provided to a different user interface and is imported into the user interface associated with the product by an administrative user.

As used herein, an “attribute” is a feature, quality, or characteristic of a product. In some cases, the term “attribute” can refer to a word or a group of words that refer to an attribute.

An embodiment of the present disclosure is used in an e-commerce context. For example, a retailer uses the data processing system to generate a ranked list of important features that consumers mention in a set of product reviews for a product, where the features are ranked in order of saliency for the product. The data processing system determines that an existing product description for the product does not include the top-ranked feature in the list based on a comparison of the product description and the list. The data processing system then uses a generative machine learning model to generate a new product description that includes the feature based on the comparison. The data processing system can provide the ranked list, the results of the comparison, and the new product description to the retailer.

The retailer is thus provided with a greater insight into a difference between how they have presented the product as opposed to how consumers have evaluated the product, and is also provided with a new product description that compensates for this discrepancy. The retailer also avoids the time and expense of examining the product reviews, comparing them with each other and the product description, and writing a new product description based on the comparison that would be incurred by using a conventional data processing system.

The data processing system therefore helps consumers to efficiently find information they need faster, and therefore facilitates a higher conversion rate for a product. Furthermore, in some cases, the data processing system offers a merchandiser an ability to enhance a product description independently of the merchandiser's skillset and without a lengthy time investment and a bias towards individual knowledge. Additionally, data insights provided by the data processing system can be used for improving product search results, fine-tuning advertisements, providing an auction pipeline, etc.

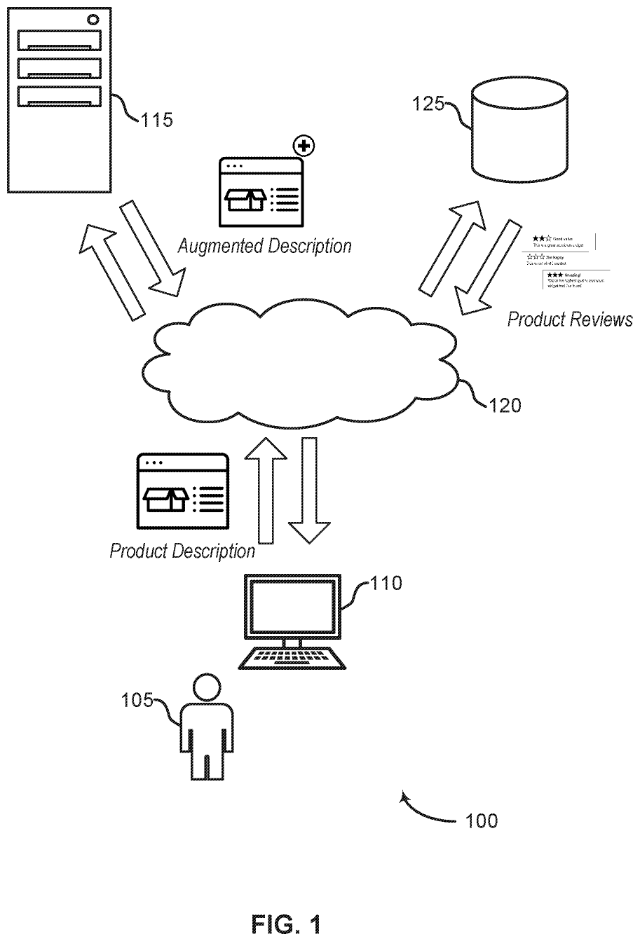

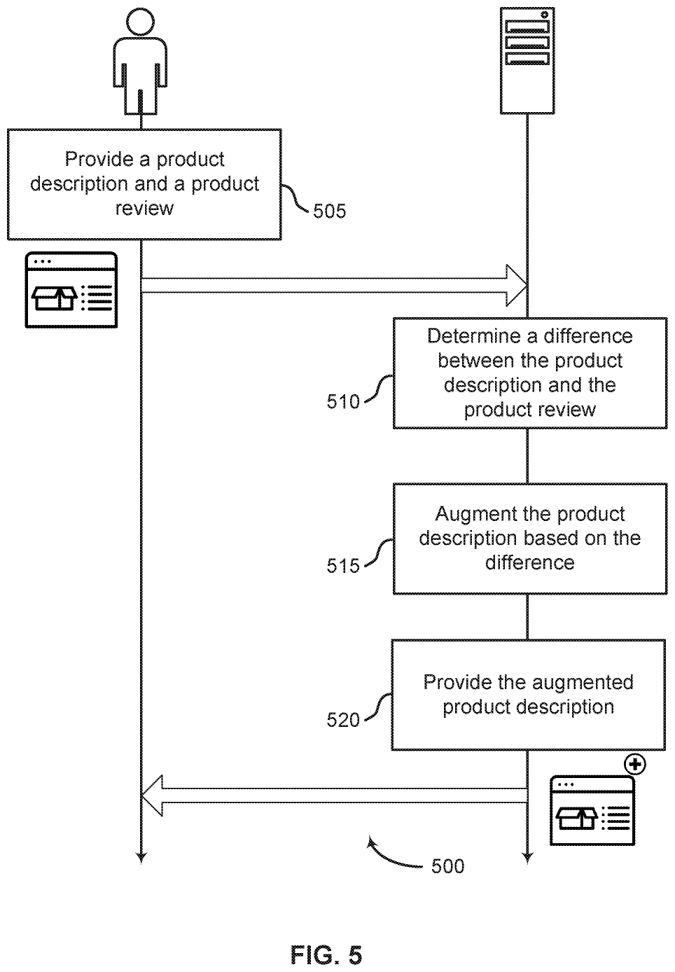

Example applications of the present disclosure in the e-commerce context are provided with reference to FIGS. 1, 3, and 5. Details regarding the architecture of the data processing system are provided with reference to FIGS. 1-4. Examples of a process for augmenting a product description are provided with reference to FIGS. 5-8.

### Data Processing System

A system and an apparatus for product description augmentation is described with reference to FIGS. 1-4. One or more aspects of the system and the apparatus include an attribute inference component configured to perform a semantic analysis of a product review for a product to obtain review data including an attribute of the product; a delta component configured to compute a difference between the review data and a product description for the product, wherein the difference includes the attribute; and a generative machine learning model configured to generate an augmented product description for the product based on the difference, wherein the augmented product description describes the attribute.

Some examples of the system and the apparatus further include a training component configured to obtain training data including a plurality of product reviews and a plurality of product descriptions and to train the generative machine learning model based on the training data.

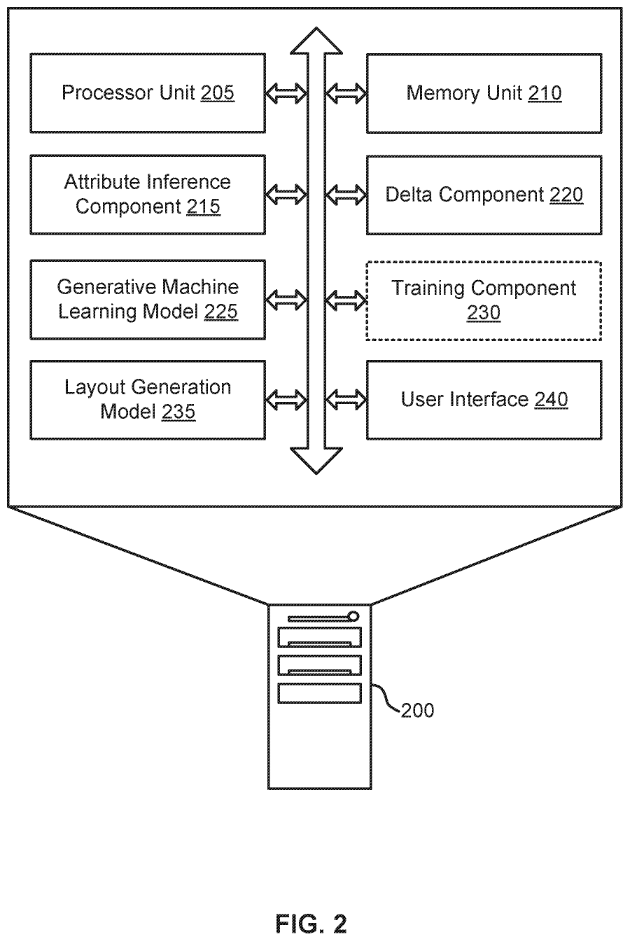

FIG. 1 shows an example of a data processing system 100 according to aspects of the present disclosure. The example shown includes data processing system 100, user 105, user device 110, data processing apparatus 115, cloud 120, and database 125. Data processing apparatus 115 is an example of, or includes aspects of, the corresponding element described with reference to FIG. 2.

Referring to FIG. 1, according to some aspects, data processing system 100 is used in an e-commerce context. For example, user 105 (such as a merchandiser) possesses a product description for a product that is intended to be displayed on a graphical user interface (such as an app or a website). User 105 provides the product description to data processing apparatus 115 via user device 110. Data processing apparatus 115 retrieves product reviews corresponding to the product description from database 125.

Data processing apparatus 115 generates an augmented product description based on the product description and the product reviews. In some cases, the augmented product description includes an attribute describing a feature of the product, where the attribute is included in the product reviews but is not included in the product description. Data processing apparatus 115 provides the augmented product description to user 105 via user device 110. Data processing apparatus 115 thereby provides an augmented product description that appropriately incorporates information that is considered valuable by consumers of the product.

According to some aspects, user device 110 is a personal computer, laptop computer, mainframe computer, palmtop computer, personal assistant, mobile device, or any other suitable processing apparatus. In some examples, user device 110 includes software that can communicate information (such as a product description, a product review, or an augmented product description) with data processing apparatus 115 and can display the augmented product description.

According to some aspects, a user interface enables user 105 to interact with user device 110. In some embodiments, the user interface may include an audio device, such as an external speaker system, an external display device such as a display screen, or an input device (e.g., a remote-control device interfaced with the user interface directly or through an I/O controller module). In some cases, the user interface may be a graphical user interface. In some cases, the graphical user interface is provided by data processing apparatus 115.

According to some aspects, data processing apparatus 115 includes a computer implemented network. In some embodiments, the computer implemented network includes a machine learning model (such as an artificial neural network described with reference to FIG. 2). Additionally, in some embodiments, data processing apparatus 115 communicates with user device 110 and database 125 via cloud 120.

In some cases, data processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessors and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of data processing apparatus 115 is provided with reference to FIGS. 2-4. Further detail regarding a process for augmenting a product description is provided with reference to FIGS. 5-8.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from a user. According to some aspects, database 125 is external to data processing apparatus 115 and communicates with data processing apparatus 115 via cloud 120. According to some aspects, database 125 is included in data processing apparatus 115.

FIG. 2 shows an example of a data processing apparatus 200 according to aspects of the present disclosure. Data processing apparatus 200 is an example of, or includes aspects of, the corresponding element described with reference to FIGS. 1 and 3-4.

In one aspect, data processing apparatus 200 includes processor unit 205, memory unit 210, attribute inference component 215, delta component 220, generative machine learning model 225, training component 230, layout generation model 235, and user interface 240.

According to some aspects, processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some embodiments, processor unit 205 includes special purpose components for modem processing, baseband processing, digital signal processing, or transmission processing.

According to some aspects, memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, attribute inference component 215 performs a semantic analysis of a product review for a product to obtain review data including an attribute of the product. In some examples, attribute inference component 215 parses the product review to obtain parsed text, where the semantic analysis is based on the parsed text. In some aspects, the parsing includes at least one of cleaning, lemmatizing, stemming, or vectorizing the product review.

According to some aspects, attribute inference component 215 includes a parsing module configured to parse the product review to obtain the parsed text. In some cases, the parsing module includes a cleaning algorithm to clean the product review or an output of the parsing module by removing unwanted characters, formatting, code tags, metadata, etc. from the product review.

In some cases, the parsing module includes a lemmatizing algorithm configured to lemmatize the product review or an output of the parsing module. Lemmatization can refer to reducing a variant wordform included in a text to a root form, known as a lemma. In some cases, the lemmatizing algorithm is handcrafted. In some cases, the lemmatizing algorithm is implemented as an artificial neural network (ANN).

An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Examples of an ANN configured to lemmatize the product review include Sequence-to-Sequence (seq2seq), a bidirectional LSTM network, LemmaProcessor, TreeTagger, and LemmaGen.

In some cases, the parsing module includes a stemming algorithm to stem the product review or an output of the parsing module. Stemming can refer to reducing text dimensionality of an input text by stripping suffixes included in the input text. Example stemming algorithms include Porter's Stemmer, Snowball Stemmer, and Lancaster Stemmer.

In some cases, the parsing module includes a vectorizing algorithm configured to vectorize the product review or an output of the parsing module. Text vectorization is a natural language processing (NLP) technique of converting text into a numerical representation of the text. Natural language processing (NLP) refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

Example vectorizing algorithms include binary term frequency, Bag of Words (BoW) term frequency, normalized term frequency, normalized term frequency-inverse document frequency, and Word2Vec. A Word2Vec model may comprise a two-layer neural network trained to reconstruct the context of terms in a document. A Word2vec model takes a corpus of documents as input and produces a vector space as output. The resulting vector space may comprise hundreds of dimensions, with each term in the corpus assigned a corresponding vector in the space. The distance between the vectors may be compared by taking the cosine between two vectors. Word vectors that share a common context in the corpus are located close to each other in the vector space.

According to some aspects, the parsing module is implemented as one or more hardware circuits, as firmware, as software stored in memory of memory unit 210 and executed by a processor of processor unit 205, or as a combination thereof.

In some examples, attribute inference component 215 determines a frequency of occurrence of words in the parsed text, where the semantic analysis is based on the frequency of occurrence. In some examples, attribute inference component 215 generates a learning-based saliency score using a saliency machine learning model, where the review data includes the learning-based saliency score. In some aspects, an input to the saliency machine learning model includes a word of the parsed text, an attribute indication, and a frequency of occurrence.

In some examples, attribute inference component 215 identifying as knowledge graph that includes the product and a set of attributes of the product. In some examples, attribute inference component 215 compares the parsed text to the knowledge graph to obtain a rule-based saliency score, where the review data includes the rule-based saliency score.

In some examples, attribute inference component 215 combines a rule-based saliency score and a learning-based saliency score to obtain a confidence score for the attribute. In some examples, attribute inference component 215 identifies a set of attributes based on the set of product reviews. In some examples, attribute inference component 215 ranks the set of attributes based on the confidence score.

In some examples, attribute inference component 215 performs a semantic analysis of an additional product review for the product to obtain additional review data including an additional attribute of the product. In some examples, attribute inference component 215 obtains user interaction data for the augmented product description. In some examples, attribute inference component 215 updates a set of attributes based on the user interaction data.

According to some aspects, attribute inference component 215 comprises a saliency machine learning model. According to some aspects, the saliency machine learning model comprises one or more artificial neural networks (ANNs). According to some aspects, the saliency machine learning model is an ANN configured to accept the parsed text as input. In some cases, the saliency machine learning model includes an output layer of artificial neurons configured to predict a number (e.g., the learning-based saliency score) between and including 0 and 1, where 0 corresponds to a 100%-confident prediction of “not a salient attribute” and 1 corresponds to a 100%-confident prediction of “a salient attribute”.

According to some aspects, the saliency machine learning model is implemented as one or more hardware circuits, as firmware, as software stored in memory of memory unit 210 and executed by a processor of processor unit 205, or as a combination thereof.

According to some aspects, attribute inference component 215 is implemented as one or more hardware circuits, as firmware, as software stored in memory of memory unit 210 and executed by a processor of processor unit 205, or as a combination thereof.

According to some aspects, delta component 220 computes a difference between the review data and a product description for the product, where the difference includes the attribute. In some examples, delta component 220 computes a subsequent difference between the additional review data and the augmented product description for the product, where the subsequent difference includes the additional attribute.

According to some aspects, delta component 220 is implemented as one or more hardware circuits, as firmware, as software stored in memory of memory unit 210 and executed by a processor of processor unit 205, or as a combination thereof.

According to some aspects, generative machine learning model 225 generates an augmented product description for the product based on the difference, where the augmented product description describes the attribute. In some examples, generative machine learning model 225 generates a subsequent augmented product description for the product based on the subsequent difference, where the subsequent augmented product description describes the additional attribute. In some examples, generative machine learning model 225 updates the augmented product description based on the updated set of attributes.

According to some aspects, generative machine learning model 225 includes one or more ANNs configured to perform natural language generation (NLG). NLG is an artificial intelligence process that outputs natural language (e.g., language developed as a result of human usage, as opposed to a constructed or formal language). Examples of ANN architectures configured to perform NLG include an encoder and decoder-based architecture (such as seq2seq), an encoder and decoder-based architecture with attention, an adversarial text generation architecture, and transformer-based models, such as BERT, GPT-2, and GPT-3.

An adversarial text generation architecture can include a generative adversarial network (GAN). A GAN is a category of ANN where two neural networks are trained based on a contest with each other. Given a training set, the network learns to generate new data with similar properties as the training set. GANs may be used in conjunction with supervised learning, semi-supervised learning, unsupervised learning, and reinforcement learning. In some examples, a GAN includes a generator network and a discriminator network. The generator network generates candidates while the discriminator network evaluates them. The generator network learns to map from a latent space to a data distribution of interest, while the discriminator network distinguishes candidates produced by the generator from the true data distribution. The generator network's training objective is to increase the error rate of the discriminator network (i.e., to produce novel candidates that the discriminator network classifies as real).

A transformer or transformer network is a type of ANN used for natural language processing tasks. A transformer network transforms one sequence into another sequence using an encoder and a decoder. The encoder and the decoder can include modules that can be stacked on top of each other multiple times. In some cases, the modules comprise multi-head attention and feed forward layers. In some cases, to the encoder inputs (e.g., target sentences) are embedded as vectors in an n-dimensional space. In some cases, positional encoding of different words (for example, an assignment for every word/part of a sequence to a relative position) are added to the embedded representation (e.g., the n-dimensional vector) of each word.

In some examples, a transformer network utilizes an attention mechanism to iteratively determine the importance of parts of the input sequence. In some cases, the attention mechanism involves a query, keys, and values denoted by Q, K, and V, respectively. In some cases, Q represents a matrix that contains the query (e.g., a vector representation of one word in the sequence), K represents the keys (e.g., vector representations of all the words in the sequence), and V represents the values, (e.g., the vector representations of all the words in the sequence). In some cases, for the multi-head attention modules of the encoder and the decoder, V comprises a same word sequence as Q. However, for an attention module that takes into account the sequences for the encoder and the decoder, V is different from a sequence represented by Q. In some cases, values in V are multiplied and summed with attention weights.

BERT is a transformer-based model that is used for natural language processing and for processing other forms of ordered data. In some examples, BERT is used as a language representation model, and is configured to pretrain deep bidirectional representations from unlabeled text by jointly conditioning on both left and right context in all layers. As a result, the pre-trained BERT model can be fine-tuned with an additional output layer to create network models for tasks such as question answering and language inference. BERT is a bi-directional model that takes into account both the context to the left and right of a given word when processing text. This allows BERT to better understand the relationships between words and their meanings in a given context. BERT can also be fine-tuned for specific tasks by adding additional output layers on top of the pre-trained model. This allows BERT to be tailored to a specific task, such as question answering or language inference, by learning task-specific features from labeled data.

GPT-2 and GPT-3 are causal language models that implement a transformer model using attention. Causal language modeling involves predicting a token after a sequence of tokens and is concerned with a left context (e.g., tokens on the left of a mask).

According to some aspects, generative machine learning model 225 is implemented as one or more hardware circuits, as firmware, as software stored in memory of memory unit 210 and executed by a processor of processor unit 205, or as a combination thereof.

According to some aspects, training component 230 obtains training data including a set of product reviews and a set of product descriptions. In some examples, training component 230 trains the generative machine learning model 225 based on the training data. According to some aspects, training component 230 obtains saliency training data including a plurality of attributes, a plurality of product descriptions, and a plurality of augmented product descriptions. In some examples, training component 230 trains the saliency machine learning model based on the saliency training data.

According to some aspects, training component 230 is implemented as one or more hardware circuits, as firmware, as software stored in memory of memory unit 210 and executed by a processor of processor unit 205, or as a combination thereof. According to some aspects, training component 230 is omitted from data processing apparatus 200 and is included in a separate apparatus that communicates with data processing apparatus 200 to train generative machine learning model 225 and/or the saliency machine learning model as described herein. In some cases, training component 230 is implemented as one or more hardware circuits of the separate apparatus, as firmware of the separate apparatus, as software stored in a memory of the separate apparatus and executed by a processor of the separate apparatus, or as a combination thereof.

According to some aspects, layout generation model 235 generates layout information for the augmented product description. According to some aspects, layout generation model 235 is implemented as one or more hardware circuits, as firmware, as software stored in memory of memory unit 210 and executed by a processor of processor unit 205, or as a combination thereof.

According to some aspects, user interface 240 displays the augmented product description based on the layout information. According to some aspects, user interface 240 is implemented as one or more hardware circuits, as firmware, as software stored in memory of memory unit 210 and executed by a processor of processor unit 205, or as a combination thereof.

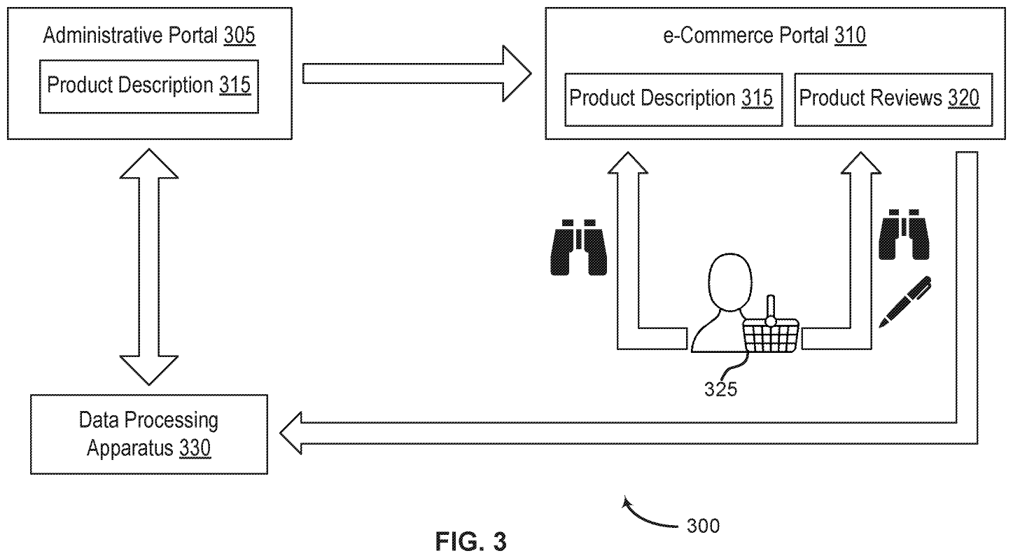

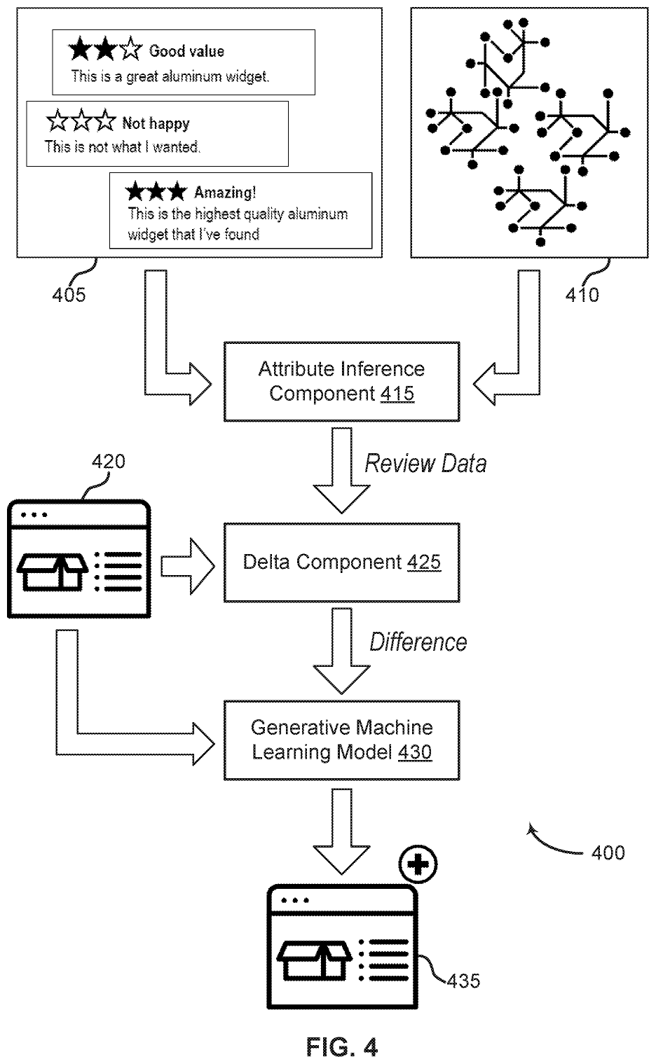

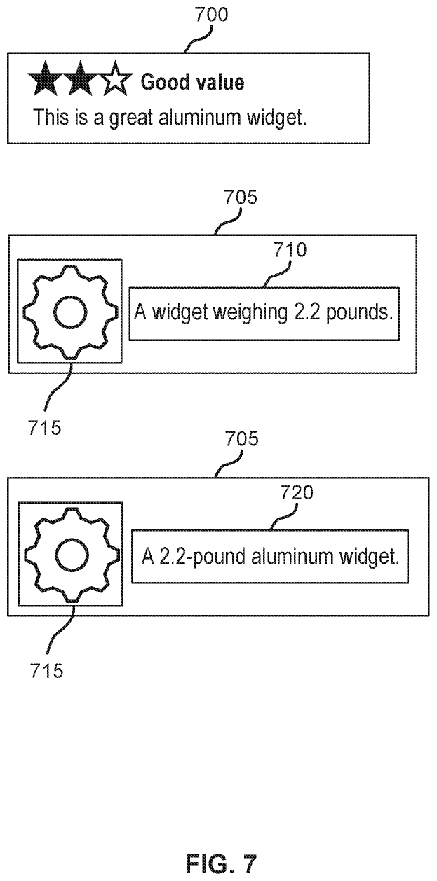

FIG. 3 shows an example of data flow in a data processing system 300 according to aspects of the present disclosure. The example shown includes administrative portal 305, e-commerce portal 310, product description 315, set of product reviews 320, consumer 325, and data processing apparatus 330. Data processing system 300 is an example of, or includes aspects of, the corresponding element described with reference to FIG. 1. Product description 315 is an example of, or includes aspects of, the corresponding element described with reference to FIGS. 4 and 7. Set of product reviews 320 is an example of, or includes aspects of, the corresponding element described with reference to FIGS. 4 and 7. Data processing apparatus 330 is an example of, or includes aspects of, the corresponding element described with reference to FIGS. 1-2 and 4.

Referring to FIG. 3, in some cases, data processing system 300 is used in e-commerce context. In an example, a user (such as a merchandiser) uploads product description 315 to administrative portal 305 (e.g., a first user interface). Administrative portal 305 provides product description 315 to e-commerce portal 310 (e.g., a second user interface) for display. Consumer 325 can view product description 315 and related product reviews 320 on e-commerce portal 310, and can also upload a product review for the product to e-commerce portal 310. In some cases, administrative portal 305 and/or e-commerce portal 310 are provided by data processing apparatus 330. In some cases, administrative portal 305 and/or e-commerce portal 310 are provided by a different apparatus.

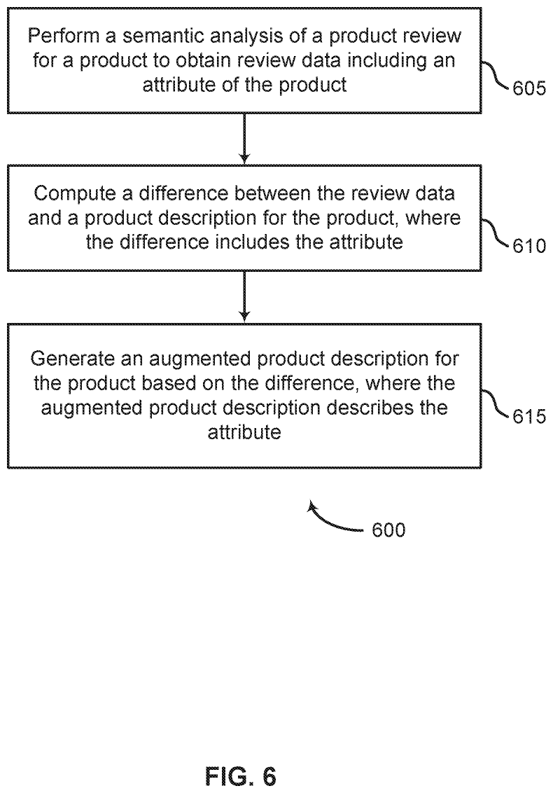

According to some aspects, data processing apparatus 330 can communicate with administrative portal 305 and/or e-commerce portal 310 to provide an augmented product description based on product description 315 and product reviews 320. For example, data processing apparatus 330 can retrieve product reviews 320 and product description 315 from e-commerce portal 310 (or an associated database, such as the database described with reference to FIG. 1), or retrieve product description 315 from administrative portal 305 (or an associated database, such as the database described with reference to FIG. 1), generate an augmented product description as described with reference to FIG. 6, and provide the augmented product description to administrative portal 305 for display on e-commerce portal 310 (or directly to e-commerce portal 310).

Accordingly, in some cases, data processing apparatus 330 intelligently traverses and parses set of product reviews 320. In some cases, data processing apparatus 330 generates a confidence score as a function of volume of product reviews in set of product reviews 320. In some cases, data processing apparatus 330 identifies key attributes that should be added to product description 315. In some cases, data processing apparatus 330 provides the key attributes to the merchandiser for approval through administrative portal 305. In some cases, data processing apparatus 330 automatically updates product description 315 without manual intervention from the merchandiser. In some cases, data processing apparatus 330 continuously learns by monitoring a click rate for the product once the augmented product description is uploaded to the e-commerce portal and accordingly fine-tunes a selection of attributes from additional product reviews provided to e-commerce portal 310.

FIG. 4 shows an example of data flow in a data processing apparatus 400 according to aspects of the present disclosure. The example shown includes data processing apparatus 400, set of reviews 405, knowledge graph 410, attribute inference component 415, product description 420, delta component 425, generative machine learning model 430, and augmented product description 435.

Data processing apparatus 400 is an example of, or includes aspects of, the corresponding element described with reference to FIGS. 1-3. Set of reviews 405 is an example of, or includes aspects of, the corresponding element described with reference to FIGS. 3 and 7. Attribute inference component 415 is an example of, or includes aspects of, the corresponding element described with reference to FIG. 2. Product description 420 is an example of, or includes aspects of, the corresponding element described with reference to FIGS. 3 and 7. Delta component 425 is an example of, or includes aspects of, the corresponding element described with reference to FIG. 2. Generative machine learning model 430 is an example of, or includes aspects of, the corresponding element described with reference to FIG. 2. Augmented product description 435 is an example of, or includes aspects of, the corresponding element described with reference to FIG. 7.

Referring to FIG. 4, according to some aspects, attribute inference component 415 obtains product reviews from set of reviews 405 (e.g., text portions of set of reviews 405) and knowledge graph 410, and generates review data as described with reference to FIG. 6. Attribute inference component 415 provides the review data to delta component 425. Delta component also obtains product description 420. Delta component 425 determines a difference based on product description 420 and the review data as described with reference to FIG. 6. Delta component 425 provides the difference to generative machine learning model 430. Generative machine learning model 430 also obtains product description 420. Generative machine learning model 430 generates augmented product description 435 as described with reference to FIG. 6.

### Product Description Augmentation

A method for product description augmentation is described with reference to FIGS. 5-8. One or more aspects of the method include performing a semantic analysis of a product review for a product to obtain review data including an attribute of the product; computing a difference between the review data and a product description for the product, wherein the difference includes the attribute; and generating an augmented product description for the product based on the difference, wherein the augmented product description describes the attribute.

Some examples of the method further include parsing the product review to obtain parsed text, wherein the semantic analysis is based on the parsed text. In some aspects, the parsing includes at least one of cleaning, lemmatizing, stemming, or vectorizing the product review.

Some examples of the method further include determining a frequency of occurrence of words in the parsed text, wherein the semantic analysis is based on the frequency of occurrence. Some examples of the method further include generating a learning-based saliency score using a saliency machine learning model, wherein the review data includes the learning-based saliency score. In some aspects, an input to the saliency machine learning model includes a word of the parsed text, an attribute indication, and a frequency of occurrence.

Some examples of the method further include identifying a knowledge graph that includes the product and a plurality of attributes of the product. Some examples further include comparing the parsed text to the knowledge graph to obtain a rule-based saliency score, wherein the review data includes the rule-based saliency score.

Some examples of the method further include combining a rule-based saliency score and a learning-based saliency score to obtain a confidence score for the attribute. Some examples of the method further include identifying a plurality of attributes based on the plurality of product reviews. Some examples further include ranking the plurality of attributes based on the confidence score.

Some examples of the method further include obtaining training data including a plurality of product reviews and a plurality of product descriptions. Some examples further include training the generative machine learning model based on the training data.

Some examples of the method further include performing a semantic analysis of an additional product review for the product to obtain additional review data including an additional attribute of the product. Some examples further include computing a subsequent difference between the additional review data and the augmented product description for the product, wherein the subsequent difference includes the additional attribute. Some examples further include generating a subsequent augmented product description for the product based on the subsequent difference, wherein the subsequent augmented product description describes the additional attribute.

Some examples of the method further include generating layout information for the augmented product description. Some examples further include displaying the augmented product description based on the layout information.

Some examples of the method further include obtaining user interaction data for the augmented product description. Some examples further include updating a set of attributes based on the user interaction data. Some examples further include updating the augmented product description based on the updated set of attributes.

FIG. 5 shows an example of a method 500 for augmenting a product description according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, a data processing system as described with reference to FIGS. 1-4 is used in an e-commerce context. For example, a user (such as a merchandiser) has uploaded a product description for a product to an e-commerce website. The e-commerce website accepts consumer reviews of the product. The merchandiser uses the data processing apparatus to determine a product attribute for the product that is prominent in the consumer reviews but is not prominent or nor included in the product description, and to then generate an augmented product description for the product that includes the attribute. The merchandiser therefore avoids the time, effort, and expense of manually examining the customer reviews to determine important information that is missing from the product review, and then redrafting the product review to include the missing information.

At operation 505, a user provide a product review and a product description for a product to the system. In some cases, the operations of this step refer to, or may be performed by, a user as described with reference to FIG. 1. For example, in some cases, the user is a merchandiser who maintains a product description displayed in an associated graphical user interface (such as an app or a website) for a product. The user can upload the product review and the product description to the data processing system, or can instruct the data processing system to retrieve the product review and the product description from a data source (such as the database described with reference to FIG. 1).

At operation 510, the system determines a difference between the product description and the product review. In some cases, the operations of this step refer to, or may be performed by, a data processing system as described with reference to FIG. 1. For example, in some cases, the data processing system parses the product review, performs a semantic analysis on the parsed product review, and determines a ranking of attributes included in the parsed product review as described with reference to FIG. 6. In some cases, the data processing system then determines the difference as described with reference to FIG. 6 based on the parsed product review and/or the ranking of attributes, where the difference relates to the attribute not being included in the product description, or the attribute not being featured prominently in the product description.

At operation 515, the system augments the product description based on the difference. For example, in some cases, the system generates an augmented product description based on the product review and the difference as described with reference to FIG. 6.

At operation 520, the system provides the augmented product description to the user. In some cases, the operations of this step refer to, or may be performed by, a data processing system as described with reference to FIG. 1. For example, in some cases, the data processing system provides the augmented product description to a user device of the user. In some cases, the data processing system displays the augmented product description in a user interface (such as the graphical user interface that included the original product description).

FIG. 6 shows an example of a method 600 for generating an augmented product description according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, according to some aspects, a data processing apparatus described with reference to FIGS. 1-4 performs method 600 for generating an augmented product description. In some cases, the data processing apparatus uses method 600 to generate an augmented product description based on a product review and an original product description, where the product review includes an attribute that is not included in the product description or is not appropriately prominent in the product description, and where the augmented product description includes the attribute. The data processing apparatus is thereby able to intelligently and automatically generate a textual description for a product by using information extracted from a product review without having to manually examine the product review, which is a time-consuming and laborious process.

At operation 605, the system performs a semantic analysis of a product review for a product to obtain review data including an attribute of the product. In some cases, the operations of this step refer to, or may be performed by, an attribute inference component as described with reference to FIG. 2.

In some cases, the data processing apparatus obtains the product review from a user (such as the user described with reference to FIGS. 1 and 4), a database (such as the database described with reference to FIG. 1), or from another source (such as a website, an example website including an e-commerce website). In some cases, the data processing apparatus obtains a set of product reviews for the product. In some cases, the data processing apparatus obtains the product review in response to an instruction from a user.

According to some aspects, the attribute inference component parses the product review to obtain parsed text. For example, in some cases, the parsing includes at least one of cleaning, lemmatizing, stemming, or vectorizing the product review. In some cases, the parsing includes removing a stop word from the product review. In some cases, the data processing apparatus parses the set of product reviews for the product to obtain the parsed text. In some cases, the semantic analysis is based on the parsed text.

According to some aspects, the attribute inference component receives tabular data for the product. In some cases, the attribute inference component obtains the tabular data from a user (such as the user described with reference to FIGS. 1 and 4), a database (such as the database described with reference to FIG. 1), or from another source (such as a website, an example website including an e-commerce website). In some cases, a first column of the tabular data corresponds to a name of the product, a second column of the tabular data corresponds to a feature as a predicate, and a third column of the tabular data corresponds to an object (e.g., a feature value) for the feature. In an example of tabular data for a widget product, an entry for the first row and first column can include the word “widget”, an entry in the first row and second column can include the word “weight”, and an entry in the first row and third column can include “2.2. pounds”. Likewise, an entry for the second row and first column can include the word “widget”, an entry in the second row and second column can include the word “material”, and an entry in the second row and third column can include “aluminum”. According to some aspects, an entry in the third column (e.g., the object column) represents an attribute of the corresponding product.

According to some aspects, the attribute inference component obtains a knowledge graph for the product. In some cases, the attribute inference component obtains the tabular data from a user (such as the user described with reference to FIGS. 1 and 4), a database (such as the database described with reference to FIG. 1), or from another source (such as a website, an example website including an e-commerce website). In some cases, the knowledge graph is a graphical representation of the tabular data for the product. In an example, the product name is represented as a subject or head node, a feature value is represented as an object or tail node, and a feature is represented as an edge connecting the subject node and the tail node. A knowledge graph can include multiple subject nodes corresponding to multiple products. In some cases, an object node can be connected to two or more subject nodes. For example, an object node corresponding to an “aluminum” feature value can be connected by multiple “material” feature edges to a “first widget” first subject node and a “second widget” second subject node. According to some aspects, a value of object node represents an attribute of the corresponding product value of the connected subject node.

According to some aspects, the attribute inference component compares the parsed text to the knowledge graph or to the tabular data. In some cases, the semantic analysis is based on the comparison. For example, in some cases, the attribute inference component attempts to match a word included in the parsed text to a value of an object node of the knowledge graph or to an entry in the object column of the tabular data. In some cases, the attribute inference component generates an alphabetically ordered list of the values of the object nodes included in the knowledge graph for efficient matching. In some cases, a node pointer for each of the object nodes is stored with the value of the object nodes in the ordered list. In some cases, a word that matches a value of an object node or an entry in the object column is an attribute of the product.

In some cases, the attribute inference component processes a given parsed text, and for each word in the text, outputs a tuple including the word, the result of the determination of whether the word is an attribute, and a frequency of occurrence of the word in the parsed text. An example parsed text includes [apple, red, yum, red, yellow]. For each word in the example parsed text, the attribute inference component outputs a tuple: [(apple, not attribute, 1), (red, attribute, 2), (yellow, attribute, 1), (yum, not attribute, 1)], where, for example, “apple” is not an attribute because “apple” does not match a value of an object node or an entry in the object column, and apple occurs once in the parsed text.

In some cases, the attribute inference component obtains a rule-based saliency score by weighting the determination of whether a word in the parsed text is an attribute by the frequency of occurrence of the word in the parsed text. In some cases, the review data includes the rule-based saliency score. In some cases, the semantic analysis is based on the frequency of occurrence.

According to some aspects, the attribute inference component provides the parsed text and the tuple output by the attribute inference component (e.g., the tuple including the word of the parsed text, the attribute indication, and the frequency of occurrence within the parsed text) to a saliency machine learning model. In some cases, for each word of the parsed text, the saliency machine learning model outputs a learning-based saliency score based on the corresponding tuple. For example, in some cases, the learning-based saliency score is a number included in the range of 0 to 1, where 0 corresponds to a 100%-confident prediction that the word does not refer to a salient attribute, 1 corresponds to a 100%-confident prediction that the word refers to a salient attribute, and 0.5 corresponds to a 50%-confident prediction that the word does not refer to a salient attribute and a 50%-confident prediction that the word refers to a salient attribute. In some cases, the review data includes the learning-based saliency score.

According to some aspects, the attribute inference component combines the rule-based saliency score and the learning-based saliency score to obtain a confidence score for the attribute. For example, in some cases, the attribute inference component computes a geographic mean of the rule-based saliency score for the attribute and the learning-based saliency score for the attribute to obtain the confidence score for the attribute.

According to some aspects, the attribute inference component identifies a set of attributes based on the plurality of product reviews. According to some aspects, the attribute inference component ranks the set of attributes based on the confidence score. For example, in some cases, the parsed text is based on the plurality of product reviews for the product. In some cases, the attribute inference component identifies a set of attributes respectively corresponding to a set of words included in the parsed text, and computes a confidence score for each attribute in the set of attributes. In some cases, the attribute inference component ranks the set of attributes based on the confidence score that corresponds to each attribute.

According to some aspects, the review data includes the confidence score. In some cases, the review data includes the word corresponding to the attribute. In some cases, the review data includes a set of words corresponding to a set of salient attributes, wherein each salient attribute of the set of salient attributes corresponds to a confidence score that exceeds a confidence score threshold.

At operation 610, the system computes a difference between the review data and a product description for the product, where the difference includes the attribute. In some cases, the operations of this step refer to, or may be performed by, a delta component as described with reference to FIG. 2.

For example, in some cases, the delta component obtains a product description for the product corresponding to the product review from a user (such as the user described with reference to FIGS. 1 and 4), a database (such as the database described with reference to FIG. 1), or from another source (such as a website, an example website including an e-commerce website). In some cases, the delta component receives the review data from the attribute inference component.

In some cases, the delta component determines a difference between the review data and the product description by comparing the product review and the review data. For example, by comparing the product review and the review data, the delta component determines that the product description does not include an attribute included in the review data, and the delta component determines that the difference includes the attribute. In some cases, the delta component determines a difference between the review data and the product description by determining that an attribute included in both the product description and in the review data does not occur enough times in the product description relative to a corresponding confidence score included in the review data. The delta component accordingly determines that the difference includes the attribute and that the attribute is not prominent enough in the product description.

According to some aspects, the delta component provides the difference (e.g., an indication of an absence of an attribute in the product description or an indication of an insufficiently prominent attribute included in the product description) to a user via a user interface (such as the user interface described with reference to FIG. 2).

At operation 615, the system generates an augmented product description for the product based on the difference, where the augmented product description describes the attribute. In some cases, the operations of this step refer to, or may be performed by, a generative machine learning model as described with reference to FIG. 2.

For example, in some cases, the generative machine learning model obtains the product description for the product corresponding to the product review from a user (such as the user described with reference to FIGS. 1 and 4), a database (such as the database described with reference to FIG. 1), or from another source (such as a website, an example website including an e-commerce website). In some cases, the delta component provides the difference to the generative machine learning model.

According to some aspects, the generative machine learning model generates an augmented product description based on the difference by receiving the difference and the product description as input and outputting an augmented product description including one or more words corresponding to the attribute in response to the input. In some cases, for example, based on a product description that does not include a word corresponding to the attribute, the generative machine learning model outputs an augmented product description that includes the word corresponding to the attribute. In some cases, for example, based on a product description that is determined to not include one or more words corresponding to an attribute frequently enough or prominently enough, the generative machine learning model outputs an augmented product description that includes one or more words corresponding to the attribute in a more relatively frequent or prominent manner than the product description (for example, by accordingly weighting the one or more words).

According to some aspects, the generative machine learning model provides the augmented product description to a user via a user interface (such as the user interface described with reference to FIG. 2. According to some aspects, a layout model described with reference to FIG. 2 generates layout information for the augmented product description. For example, the layout model determines a placement of the augmented product description within an external context (such as positioning within a graphical user interface), where the layout information relates to the placement. According to some aspects, a user interface described with reference to FIG. 2 displays the augmented product description based on the layout information. According to some aspects, the augmented product description is displayed for the product within a graphical user interface associated with the product (such as an app or a website). According to some aspects, the augmented product description is displayed in a graphical user interface that displayed the product description. An example of an augmented product description is provided with reference to FIG. 7.

According to some aspects, a training component described with reference to FIG. 2 obtains training data including a set of product reviews and a set of product descriptions. According to some aspects, the training component trains the generative machine learning model based on the training data.

For example, in some cases, the training component trains the generative machine learning model based on a comparison of the augmented product description, the set of product reviews, and the product description using a supervised learning process. Supervised learning is one of three basic machine learning paradigms, alongside unsupervised learning and reinforcement learning.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

A “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the training component updates the parameters of the generative machine learning model accordingly, and a new set of predictions (e.g., a new set of augmented product descriptions) are made during the next iteration.

Likewise, according to some aspects, the training component obtains saliency training data including a set of attributes, a set of product descriptions, and a set of augmented product descriptions. According to some aspects, the training component trains the saliency machine learning model based on the saliency training data using a supervised learning process to output the learning-based saliency score. According to some aspects, the saliency training data is gradually curated over time as a function of a result of the product description augmentation process (e.g., whether words corresponding to identified salient attributes are included in the augmented product description).

According to some aspects, the training component obtains saliency training data including a set of attributes, a set of product descriptions, and a set of augmented product descriptions. According to some aspects, the training component trains the saliency machine learning model based on the saliency training data.

According to some aspects, the attribute inference component obtains user interaction data for the augmented product description. For example, in some cases, a third-party user (such as a consumer) provides user interaction data (such as an additional product review or a click rate on a hyperlink associated with the augmented product description) to a graphical user interface associated with the augmented product description. In some cases, the attribute inference component obtains the user interaction data (for example, from a user, a database, or other data sources, such as the graphical user interface).

According to some aspects, the attribute inference component updates a set of attributes based on the user interaction data. For example, the attribute inference component determines an attribute included in the user interaction data in a similar manner as described above (for example, by parsing the user interaction data and performing a semantic analysis on the parsed user interaction data to determine a confidence score for the attribute). In some cases, the attribute inference component adds the attribute included in the user interaction data to a set of attributes including the attribute included in the parsed review text.

According to some aspects, the generative machine learning model updates the augmented product description based on the updated set of attributes. For example, in some cases, the attribute inference component provides the updated set of attributes and a corresponding updated set of confidence scores to the delta component. In some cases, the delta component determines a difference, as described above, based on the updated set of attributes and/or the updated set of confidence scores. In some cases, the generative machine learning model generates an updated augmented product description based on the augmented product description and the difference as described above. In some cases, the data processing apparatus displays the updated augmented product description via a user interface.

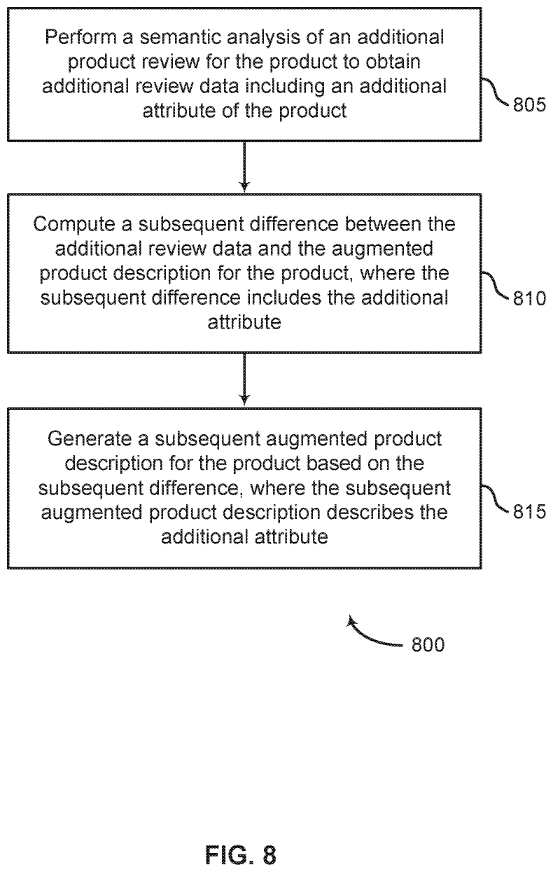

According to some aspects, the data processing system generates a subsequent augmented product description. For example, in some cases, the data processing system runs on a continuous basis by retrieving additional product reviews at a fixed cadence or by retrieving the subsequent product reviews as a function of a volume of additional product reviews that are uploaded to a data source (such as a database or other data source associated with the product). In some cases, the data processing system thereby provides a subsequent augmented product description that incorporates new information included in additional product reviews (and that may reflect the current interests of users of the product). A method for generating the subsequent augmented product description is described with reference to FIG. 8.

FIG. 7 shows an example of an augmented product description according to aspects of the present disclosure. The example shown includes review 700, graphical user interface 705, product description 710, product image 715, and augmented product description 720.

Referring to FIG. 7, in some cases, review 700 is displayed in a graphical user interface (such as a website or an app). In an example, review 700 includes an image portion (the stars) and a text portion. In some cases, the text portion is the product review described with reference to FIG. 6. A data processing apparatus described with reference to FIGS. 1-4 determines, as described with reference to FIG. 6, that a word “aluminum” included in the product review refers to an attribute of a widget, and that the attribute is not represented in product description 710. Based on the determination and product description 710 (shown within graphical user interface 705, alongside product image 715), the data processing apparatus generates augmented product description 720 as described with reference to FIG. 6. In the example shown, augmented product description 720 features the attribute “aluminum” and is displayed according to layout information in graphical user interface 705 in place of product description 710 alongside product image 715.

FIG. 8 shows an example of a method 800 for generating a subsequent augmented product description according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system performs a semantic analysis of an additional product review for the product to obtain additional review data including an additional attribute of the product. In some cases, the operations of this step refer to, or may be performed by, an attribute inference component as described with reference to FIG. 2. For example, in some cases, the attribute inference component obtains an additional product review associated with the product described with reference to FIG. 6 and performs a semantic analysis as described with reference to FIG. 6.

At operation 810, the system computes a subsequent difference between the additional review data and the augmented product description for the product, where the subsequent difference includes the additional attribute. In some cases, the operations of this step refer to, or may be performed by, a delta component as described with reference to FIG. 2. For example, in some cases, the delta component determines the difference in a similar manner as described with reference to FIG. 6.

At operation 815, the system generates a subsequent augmented product description for the product based on the subsequent difference, where the subsequent augmented product description describes the additional attribute. In some cases, the operations of this step refer to, or may be performed by, a generative machine learning model as described with reference to FIG. 2. For example, in some cases, the generative machine learning model generates the subsequent augmented product description in a similar manner as described with reference to FIG. 6. In some cases, the data processing apparatus displays the subsequent augmented product description via a user interface. According to some aspects, the subsequent augmented product description is displayed for the product within a graphical user interface associated with the product (such as an app or a website). According to some aspects, the subsequent augmented product description is displayed in a graphical user interface that displayed the augmented product description.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
performing, by an attribute inference component, a semantic analysis of a product review for a product to obtain review data including an attribute of the product;
computing, by a delta component, a difference between the review data and a product description for the product, wherein the difference includes the attribute; and
generating, by a generative machine learning model, an augmented product description for the product based on the difference, wherein the augmented product description describes the attribute.

2. The method of claim 1, further comprising:
parsing, by the attribute inference component, the product review to obtain parsed text, wherein the semantic analysis is based on the parsed text.

3. The method of claim 2, wherein:
the parsing includes at least one of cleaning, lemmatizing, stemming, or vectorizing the product review.

4. The method of claim 2, further comprising:
determining, by the attribute inference component, a frequency of occurrence of words in the parsed text, wherein the semantic analysis is based on the frequency of occurrence.

5. The method of claim 2, further comprising:
generating, by the attribute inference component, a learning-based saliency score using a saliency machine learning model, wherein the review data includes the learning-based saliency score.

6. The method of claim 5, wherein:
an input to the saliency machine learning model includes a word of the parsed text, an attribute indication, and a frequency of occurrence.

7. The method of claim 2, further comprising:
identifying, by the attribute inference component, a knowledge graph that includes the product and a plurality of attributes of the product; and
comparing, by the attribute inference component, the parsed text to the knowledge graph to obtain a rule-based saliency score, wherein the review data includes the rule-based saliency score.

8. The method of claim 1, further comprising:
combining, by the attribute inference component, a rule-based saliency score and a learning-based saliency score to obtain a confidence score for the attribute.

9. The method of claim 8, further comprising:
identifying, by the attribute inference component, a plurality of attributes based on a plurality of product reviews; and
ranking, by the attribute inference component, the plurality of attributes based on the confidence score.

10. The method of claim 1, further comprising:
obtaining, by a training component, training data including a plurality of product reviews and a plurality of product descriptions; and
training, by the training component, the generative machine learning model based on the training data.

11. The method of claim 1, further comprising:
performing, by the attribute inference component, a semantic analysis of an additional product review for the product to obtain additional review data including an additional attribute of the product;
computing, by the delta component, a subsequent difference between the additional review data and the augmented product description for the product, wherein the subsequent difference includes the additional attribute; and
generating, by the generative machine learning model, a subsequent augmented product description for the product based on the subsequent difference, wherein the subsequent augmented product description describes the additional attribute.

12. The method of claim 1, further comprising:
generating, by a layout model, layout information for the augmented product description; and
displaying, by a user interface, the augmented product description based on the layout information.

13. The method of claim 1, further comprising:
obtaining, by the attribute inference component, user interaction data for the augmented product description;
updating, by the attribute inference component, a set of attributes based on the user interaction data; and
updating, by the generative machine learning model, the augmented product description based on the updated set of attributes.

14. A non-transitory computer readable medium storing instructions that, when executed by a processor, cause the processor to:
perform a semantic analysis of a product review for a product to obtain review data including an attribute of the product;
compute a difference between the review data and a product description for the product, wherein the difference includes the attribute; and
generate an augmented product description for the product based on the difference, wherein the augmented product description describes the attribute.

15. The non-transitory computer readable medium of claim 14, wherein the instructions further cause the processor to:
combine a rule-based saliency score and a learning-based saliency score to obtain a confidence score for the attribute.

16. The non-transitory computer readable medium of claim 15, wherein the instructions further cause the processor to:
identify a plurality of attributes based on a plurality of product reviews; and
rank the plurality of attributes based on the confidence score.

17. The non-transitory computer readable medium of claim 14, wherein the instructions further cause the processor to:
obtain training data including a plurality of product reviews and a plurality of product descriptions; and
train a generative machine learning model based on the training data.

18. The non-transitory computer readable medium of claim 14, wherein the instructions further cause the processor to:
perform a semantic analysis of an additional product review for the product to obtain additional review data including an additional attribute of the product;
compute a subsequent difference between the additional review data and the augmented product description for the product, wherein the subsequent difference includes the additional attribute; and
generate a subsequent augmented product description for the product based on the subsequent difference, wherein the subsequent augmented product description describes the additional attribute.

19. An apparatus for data processing, comprising:
a processor;
a memory storing instructions executable by the processor;
an attribute inference component configured to perform a semantic analysis of a product review for a product to obtain review data including an attribute of the product;
a delta component configured to compute a difference between the review data and a product description for the product, wherein the difference includes the attribute; and
a generative machine learning model configured to generate an augmented product description for the product based on the difference, wherein the augmented product description describes the attribute.

20. The apparatus of claim 19, further comprising:
a training component configured to obtain training data including a plurality of product reviews and a plurality of product descriptions and to train the generative machine learning model based on the training data.
